(19) United States
(12) Patent Application Publication
(10) Pub. No.: US 2007/0047422 A1
(43) Pub. Date: Mar. 1, 2007

(54) Compatible optical pickup and an optical recording and/or reproducing apparatus employing a compatible optical pickup

(75) Inventors: Tae-kyung Kim, Seoul (KR); Jin-won Lee, Seongnam-si (KR); Kyong-tae Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co.Ltd., Suwon-si (KR)

(21) Appl. No.: 11/510,562

(22) Filed: Aug. 28, 2006

(30) Foreign Application Priority Data
Aug. 29, 2005 (KR) 2005-79444

(51) Int. Cl. G11B 7/135

(52) U.S. Cl. 369/112.1

(57) ABSTRACT

A compatible optical pickup including an active compensation device to actively switch an angle of incidence of the light on the objective lens when either a third information storage medium that has a different format than that of the first and second information storage media, or the second information storage medium is adopted for use in a data recording/reproducing operation. The active compensation device includes a plurality of transparent substrates, and at least one material layer, interposed between the plurality of substrates, having a refractive index which is actively switched according to an applied voltage. A holographic pattern, formed adjacent to the material layer on a surface of at least one of the transparent substrates, changes a divergence angle of the light by diffracting or transmitting without diffraction the incident light according to change of the refractive index of the material layer. The voltage applied to the material layer is adjusted according to the applied information storage medium that is adopted for the use in the data recording/reproducing operation.

### CROSS-REFERENCE TO RELATED PATENT APPLICATION

This application claims the benefit of Korean Patent Application No. 2005-79444, filed Aug. 29, 2005, in the Korean Intellectual Property Office, the disclosure of which is incorporated herein in its entirety by reference.

### BACKGROUND OF THE INVENTION

1. Field of the Invention

Aspects of the present invention relate to an optical pickup and an optical recording and/or reproducing apparatus employing an optical pickup, and, more particularly, to a compatible optical pickup, which is compatible with a plurality of information storage media standards using one objective lens, and an optical recording and/or producing apparatus employing the compatible optical pickup.

2. Description of the Related Art

Optical recording and/or reproducing apparatuses record information on and/or reproduce information from an information storage optical disc by focusing a laser beam on the optical disc with an objective lens. In optical recording and/or reproducing apparatuses, a recording capacity is determined by the size S of a light spot generated by the focusing of the laser beam on the information storage optical disc. The relationship between the size S of the focused spot to the wavelength (λ) of the laser beam and the numerical aperture (NA) of the objective lens is:
S∝λ/NA (1)

Accordingly, to form a small light spot to allow for high-density recording, adopting a short wavelength light source, such as a blue laser, to emit light having a short wavelength, and using an objective lens having a high NA greater than 0.6 is essential.

Recently, a blu-ray disc (BD) standard has been suggested that achieves the above-noted goal. Here, a light source with a wavelength of approximately 405 nm, an objective lens with an NA of 0.85, and an optical disc with a capacity of approximately 25 giga bytes (GB) and a thickness (an interval between a light-incident plane and an information storage surface, corresponding to the thickness of a protective layer in this case) of 0.1 mm are used. A high-definition digital versatile disc (HD DVD) standard has also been suggested. Here, a light source with a wavelength equal to that used by the BD standard, an objective lens with an NA of 0.65, and an optical disc with a capacity of about 15 GB and a thickness (an interval between a light incident-plane and an information storage surface, corresponding to the thickness of a substrate in this case) of 0.6 mm are used.

Therefore, a device that is compatible with at least two optical disc standards, such as the blu-ray standard and the HD DVD standard, is needed.

Briefly, it is noted that DVD standards, such as DVD-RAM standards and DVD ±RW standards, use light sources with similar wavelengths, objective lenses with similar NAs, and optical disc substrates with similar thicknesses. According to those standards, only a track pitch and an optical disc structure vary. As such, since an operation of condensing light that is emitted from a light source onto an optical disc is substantially similar regardless of the optical disc standard, a method of performing focusing and tracking that is compatible with various track pitches has been considered. However, since the thicknesses of optical discs are different in the case of next-generation DVD standards such as the BD and HD DVD standards, the generation of spherical aberration due to a difference in the thicknesses of the new types of optical discs is severe. Accordingly, compensating for spherical aberration is required.

To compensate for the spherical aberration caused by the difference in thicknesses of new types of the optical discs when one light source is used, a first method, in which a holographic optical element (HOE) is used, and a second method, in which two objective lenses are used, have each been suggested.

A method of compensating for spherical aberration caused by a difference in thickness of two optical disks by diffracting light emitted from one light source into zero^{th} order light and first order light using an HOE has a disadvantage in that, since light is separated into two light beams, light efficiency is reduced to half of the original light efficiency. Due to this low light efficiency, high speed operation requiring high light intensity cannot be performed. Japanese Patent Laid-open Publication No. 1996-62493 discloses one such method of compatibly adopting a compact disc (CD) family optical disc using an HOE and a light source for DVDs.

Meanwhile, Japanese Patent Laid-open Publication No. hei 8-252697 discloses a method using a shaft sliding type actuator and two objective lenses. The method is complex and has low sensitivity and high non-linearity. Thus, the method disclosed in the '697 publication is also not suitable for use with high speed and high precision optical recording or reproducing apparatuses. When the two objective lenses are fixed, the number of optical components increases and adjusting an optical axis is relatively difficult compared with a case when one objective lens is used.

U.S. Pat. No. 6,213,131 discloses an optical pickup to compensate for spherical aberration caused by a difference in thickness of optical discs using one light source and a liquid crystal device. The optical pickup disclosed by this patent corrects spherical aberration using the liquid crystal device to compatibly adopt HD DVD, DVD, and CD standards.

Since the liquid crystal device has a single liquid crystal layer, an electrode is divided into a plurality of regions and a voltage applied to the liquid crystal layer is adjusted for each region to change a diffraction angle. The single liquid crystal layer may change the diffraction angle to 0° or a predetermined diffraction angle θ₁. However, to change the diffraction into another diffraction angle θ₂, the electrode needs to be formed in a complex structure or two or more liquid crystal layers are required. Accordingly, the structure of the liquid crystal device of the '131 patent is complex, light transmittance is low, and costs are high.

### SUMMARY OF THE INVENTION

An aspect of the present invention provides a compatible optical pickup which compensates for spherical aberration to be compatible with three or more information storage medium standards using one objective lens and has a simple electrode structure for an aberration compensation device, resulting in increased luminous efficiency, and an optical recording and/or reproducing apparatus employing the compatible optical pickup.

According to an aspect of the present invention, there is provided a compatible optical pickup comprising: a light source to emit light; an objective lens that focuses the light to be incident on information storage media and which is optimized for use with a first information storage medium to which the light emitted from the light source is irradiated; a first optical system to emit light suitable for use with a second information storage medium, the first optical system being configured as a finite optical system; and an active compensation device to actively switch an angle of incidence of the light on the objective lens when either a third information storage medium that has a different format from that of the first and second information storage media, or the second information storage medium is adopted for use in a data recording/reproducing operation, wherein the active compensation device comprises: a plurality of transparent substrates; and at least one material layer, interposed between the plurality of substrates, having a refractive index which is actively switched according to an applied voltage, wherein a holographic pattern, formed adjacent to the material layer on a surface of at least one of the transparent substrates, changes a divergence angle of the light by diffracting or transmitting without diffraction the incident light according to a change of the refractive index of the material layer, and wherein the voltage applied to the material layer is adjusted according to the applied information storage medium that is adopted for the use in the data recording/reproducing operation.

The first and third information storage media may be respectively a blu-ray disc (BD) and a high-definition digital versatile disc (HD DVD) or vice versa, and the second information storage medium may be at least one of a digital versatile disc (DVD) and a compact disc (CD), wherein the first optical system emits light suitable for at least one of the DVD and the CD to record or reproduce information on at least one of the DVD and the CD.

The wavelength of the light source may be approximately 400 nm, the thickness of the first information storage medium may be approximately 0.1 mm, and the effective numerical aperture of the objective lens for the first information storage medium may be approximately 0.85; the wavelength of the light suitable for the DVD may be approximately 650 nm, the thickness of the DVD may be approximately 0.6 mm, and the effective numerical aperture of the objective lens for the DVD may be approximately 0.60; the wavelength of the light suitable for the CD may be approximately 780 nm, the thickness of the CD may be approximately 1.2 mm, and the effective numerical aperture of the objective lens for the CD may be approximately 0.45; and the thickness of the third information storage medium may be approximately 0.6 mm and the effective numerical aperture of the objective lens for the third information storage medium may be approximately 0.65.

The compatible optical pickup may further comprise a second optical system emitting light suitable for the third information storage medium to record or reproduce information on the third information storage medium, wherein the first information storage medium is any one of a BD and a HD DVD, and the second and third information storage media are respectively a DVD and a CD or vice versa.

The second optical system may be an infinite optical system.

The wavelength of the light source may be approximately 400 nm, and the thickness of the first information storage medium and the effective numerical aperture of the objective lens for the first information storage medium may be approximately 0.1 mm and 0.85, respectively, or 0.6 mm and 0.65, respectively; the wavelength of the light suitable for the DVD may be approximately 650 nm, the thickness of the DVD may be approximately 0.6 mm, and the effective numerical aperture of the objective lens for the DVD may be approximately 0.60; and the wavelength of the light suitable for the CD may be approximately 780 nm, the thickness of the CD may be approximately 1.2 mm, and the effective numerical aperture of the objective lens for the CD may be approximately 0.45.

When a difference between the refractive indices of the transparent substrate on which the holographic pattern is formed and the material layer is Δn, the depth of the holographic pattern is d, the wavelength of incident light is λ, and the order of diffracted light is m, the holographic pattern may be formed to a depth satisfying
(Δn·λ−1)d=m·λ.

The active compensation device may be formed to act on the polarization of light incident on the information storage medium and the polarization of light reflected by the information storage medium, respectively.

The compatible optical pickup may further comprise a quarter wave plate that is interposed between the active compensation device and the information storage medium and changes the polarization of incident light.

The material layer and the holographic pattern of the active compensation device may respectively comprise: a first material layer and a first holographic pattern acting on the light incident on the information storage medium; and a second material layer and a second holographic pattern acting on the light reflected by the information storage medium.

The active compensation device may switch incidence angle of light irrespective of the polarization of the light.

According to another aspect of the present invention, there is provided an optical recording and/or reproducing apparatus comprising: the optical pickup of movable along a radial direction of an information storage medium and recording or reproducing information to or from the information storage medium; and a control unit controlling the optical pickup.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a compatible optical pickup according to an embodiment of the present invention;

FIG. 2 is a side sectional view of an active compensation device which is applied to the compatible optical pickup according to the present invention;

FIG. 3 is a plan view of a holographic pattern of the active compensation device FIG. 2;

FIGS. 4A and 4B are sectional views illustrating the operating principle of the active compensation device of FIG. 2;

FIG. 5 is a graph illustrating diffraction efficiency at wavelengths of 408 nm, 785 nm, and 660 nm according to the depth of the holographic pattern when a hologram element is made of silica;

FIG. 6 is a sectional view of an embodiment of an active compensation device which is applied to the compatible optical pickup of FIG. 1 according to the present invention;

FIGS. 7A through 7D illustrate optical paths of light for a blu-ray disc (BD), a high-definition digital versatile disc (HD DVD), a digital versatile disc (DVD), and a compact disc (CD) according to the adjustment of applied voltage into the active compensation device when an active compensation device and the objective lens are designed based on data from Tables 1 and 2;

FIGS. 8A through 8D respectively illustrate aberration when an active compensation device and an objective lens designed based on the data of Tables 1 and 2 are configured to form the optical paths of 7A through 7D with respect to the BD, HD DVD, DVD, and CD;

FIGS. 9A through 9C respectively illustrate aberration with respect to the BD, DVD, and CD according to the adjustment of applied voltage into the active compensation device when the active compensation device and the objective lens are designed based on data of Tables 3 and 4;

FIG. 10 illustrates a compatible optical pickup according to another embodiment of the present invention; and

FIG. 11 illustrates an optical recording and/or reproducing apparatus employing a compatible optical pickup according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

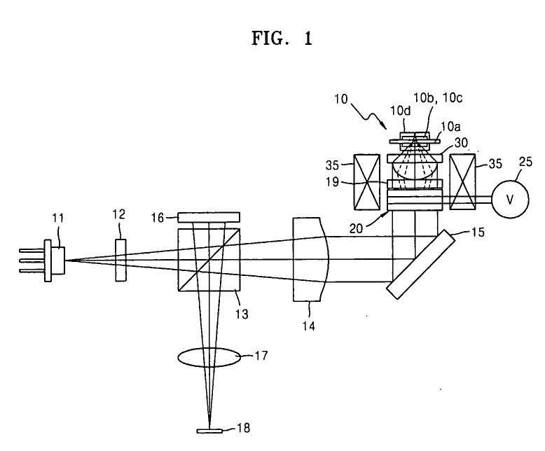

FIG. 1 illustrates a compatible optical pickup according to an embodiment of the present invention, which may be compatible with a digital versatile disc (DVD) 10c, a compact disc (CD) 10d, a blu-ray disc (BD) 10a, a high-definition digital versatile disc (HD DVD) 10b and/or a combination thereof. Although the compatible optical pickup employs both a light source for the CD 10d and a light source for the DVD 10c in FIG. 1, the compatible optical pickup may include only one of the two light sources to be compatible with the DVD 10c and the CD 10d.

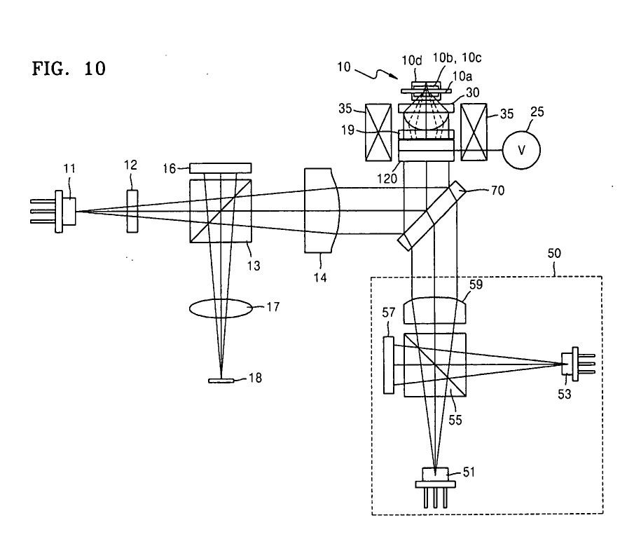

As shown in FIG. 1, the compatible optical pickup includes a light source 11, an objective lens 30 that is optimized for a first information storage medium (e.g., the BD 10a), an active compensation device 20 to actively switch an angle of incidence of light on the objective lens 30 according to a type of information storage medium being used, and an optical system 50 (see FIG. 10) for use with low density information storage media (e.g., the DVD 10c and the CD 10d).

The compatible optical pickup may further include an optical path changer 15 that is interposed between the light source 11 and the objective lens 30 to change an optical path of light, a photodetector 18 to receive light that is reflected by the information storage medium 10 and which passes through the objective lens 30 and the optical path changer 15, and an optical path coupler 70 to couple an optical path of light emitted from the optical system 50 for use with low density information storage media with the optical path of light emitted from the light source 11 for the BD 10a and the HD DVD 10b so that the light emitted from the optical system 50 for use with low density information storage media may be directed toward the objective lens 30.

The light source 11 emits light that is commonly used for a first information storage medium with a predetermined format, for example, the BD 10a, which has a thickness of approximately 0.1 mm and a second information storage medium with a different format, for example, the HD DVD 10b, which has a thickness of approximately 0.6 mm. For example, when the first and second information storage media are the BD 10a and the HD DVD 10b, respectively, the light source 11 emits blue light having a wavelength of approximately 400-420 nm. The light source 11, therefore, may be a semiconductor laser that emits blue light having a wavelength of approximately 400 nm.

The objective lens 30 focuses the incident light on the information storage medium 10. The objective lens 30 may be optimized for the BD 10a so that when light having a wavelength of about 400 nm is incident thereon, the objective lens 30 forms an optimal light spot on the BD 10a with a thickness of approximately 0.1 mm at an effective numerical aperture (NA) of approximately 0.85. Alternatively, when the compatible optical pickup is formed to be compatible with both the HD DVD 10b and the low density information storage media DVD 10c and CD 10d, the objective lens 30 is optimized for the HD DVD 10b so that when light having a wavelength of about 400 nm is incident thereon, the objective lens 30 forms an optimal light spot on the HD DVD 10b with a thickness of approximately 0.6 mm at an effective NA of approximately 0.65.

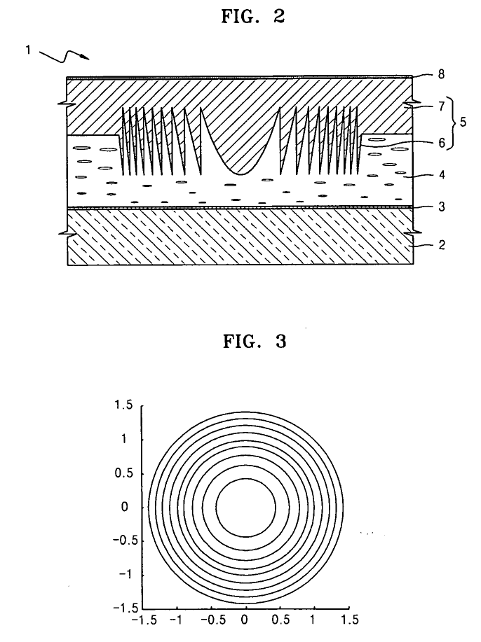

As will be described later with reference to FIGS. 2 through 6, the active compensation device 20 includes at least one material layer that is interposed between two transparent substrates and has a refractive index which is switched according to a voltage applied from an electric power source 25. A holographic pattern is formed adjacent to the material layer on a surface of the transparent substrate so as to change a divergence angle of light by selectively diffracting incident light according to the refractive index of the material layer. When the material layer is a liquid crystal layer that is aligned to switch a refractive index thereof only for light having a predetermined polarization, the active compensation device 20 may provide polarization selectivity.

The voltage applied to the material layer is adjusted so as to maximize diffraction efficiency at the particular wavelength of light that is suitable for use with a particular applied information storage medium.

For example, when the BD 10a having a thickness for which the objective lens 30 is optimized is used as the information storage medium 10 to record/reproduce information onto/from the information storage medium 10, a first voltage V1 is applied to the active compensation device 20, such that the refractive indices of the transparent substrate, on which the holographic pattern is formed, and the liquid crystal are made to be substantially equal to each other so as to transmit light as parallel light. When the HD DVD 10b, which requires light with the same wavelength as the BD 10a but which has a substrate with a different thickness from the BD 10a and requires a different NA than the BD 10a, is used, a second voltage V2 is applied to the active compensation device 20, such that the refractive indices of the transparent substrate, on which the holographic pattern is formed, and the liquid crystal are different from each other so as to maximize light diffraction efficiency.

When a third information storage medium, e.g., the DVD 10c, which requires light with a different wavelength and a different NA than the BD 10a, and which has a substrate with a different thickness than the BD 10a, is used, a third voltage V3 is applied to the active compensation device 20. Here, the refractive indices of the transparent substrate, on which the holographic pattern is formed, and the liquid crystal are different from each other so as to maximize light diffraction efficiency at the wavelength of the light source for the DVD 10c.

When a fourth information storage medium, e.g., the CD 10d, which requires light with a different wavelength and a different NA than the BD 10a, and which has a substrate with a different thickness than the BD 10a, is used, a fourth voltage V4 is applied to the active compensation device 20. Here, the refractive indices of the transparent substrate, on which the holographic pattern is formed, and the liquid crystal are different from each other so as to maximize light diffraction efficiency at the wavelength of the light source for the CD 10d.

Meanwhile, as shown in FIG. 1, the optical system 50 for low density information storage media includes a first optical module 51 for the DVD 10c, a second optical module 53 for the CD 10d, and a beam splitter 55 that couples optical paths of light that are incident from the first and second optical modules 51 and 53 so as to guide the light along the same optical path, and to direct light that is reflected by the information storage medium 10 toward the first and second optical modules 51 and 53. The optical system 50 includes a collimating lens 59 for the DVD 10c and the CD 10d interposed between the beam splitter 55 and the optical path coupler 70 to collimate light incident from the first and second optical modules 51 and 53. As shown in FIG. 10, a monitoring photodetector 57 monitors the amount of light output from the first optical module 51 for the DVD 10c and the second optical module 53 for the CD 10d.

In an embodiment of the invention, the first optical module 51 comprises a hologram optical module for use with the DVD 10c employing a light source that emits light having a red wavelength of approximately 650 nm (i.e., red light). The second optical module 53 comprises a hologram optical module for the CD 10d employing a light source that emits light having a red wavelength of approximately 780 nm (i.e., infrared light). Each of the hologram optical modules includes a light source, a photodetector to detect a signal, and a hologram to directly transmit light emitted from the light source without diffraction and to diffract light reflected by the information storage medium 10 into first order light so as to direct the light toward the photodetector. The hologram optical module may further include a grating pattern formed on a surface of a transparent member that is positioned opposite to the surface of the transparent member on which the hologram is formed such that the grating pattern divides incident light into at least three light beams so as to detect a tracking error signal by using a 3-beam method. The hologram optical module is well known in the field. Thus, a detailed explanation thereof will not be given.

Alternatively, to be compatible adopt with the DVD 10c and/or the CD 10d, the compatible optical pickup may include a separate optical system in which the light source and the photodetector are separately installed. In fact, the optical structure of the optical system 50 for low density information storage media in the compatible optical pickup may be modified in various ways.

When the compatible optical pickup is compatible with the BD 10a, the HD DVD 10b, the DVD 10c, and the CD 10d, the optical system 50 for low density information storage media has a finite optical system for each wavelength of light that is suitable for use with the DVD 10c and each wavelength of light that is suitable for use with the CD 10d. That is, in this situation, the optical system 50 for low density information storage media includes an optical system for the DVD 10c and an optical system for the CD 10d, with both optical systems being finite optical systems.

In detail, in this situation, divergent light is emitted from the light source for the DVD 10c that is embedded in the first optical module 51 and, similarly, divergent light is emitted from the light source for the CD 10d embedded in the second optical module 53. Accordingly, when the first and second optical modules 51 and 53 and the collimating lens 59 are arranged to produce slightly divergent light for the DVD 10c and light for the CD 10d, the optical system 50 for low density information storage media forms respectively finite optical systems for the light for the DVD 10c and the light for the CD 10d.

The reason why the optical system for the DVD 10c and the optical system for the CD 10d should be finite optical systems will now be explained.

When an electrode structure of the active compensation device 20 is simplified, a diffraction angle of light at all wavelengths does not change as much as may be desired when a voltage applied to the liquid crystal is changed. Hence, optimizing a diffraction angle made by the active compensation device 20 for each of the information storage media including the HD DVD 10b, the DVD 10c, and the CD 10d may be difficult. However, if the active compensation device 20 is configured to diffract blue light that is suitable for use with the HD DVD 10b at an optimal diffraction angle and the optical system for the DVD 10c and the optical system for the CD 10d are finite optical systems, red light that is suitable for use with the DVD 10c and infrared light suitable for use with the CD 10d is divergent when incident on the active compensation device 20. Accordingly, the active compensation device 20 also diffracts light for the DVD 10c and the CD 10d at a proper diffraction angle.

When the BD 10a, the HD DVD 10b, the DVD 10c, and the CD 10d are compatibly adopted as described above, the wavelength of the light source 11 is approximately 400-420 nm. When the BD 10a having a thickness of 0.1 mm is used, the effective NA of the objective lens 30 is approximately 0.85. Since a divergence angle of light is adjusted by the active compensation device 20 and since the optical system 50 for low density information storage media is a finite optical system, when the HD DVD 10b having a thickness of approximately 0.6 mm is used, the effective NA of the objective lens 30 is approximately 0.65. Also, when light having a wavelength of approximately 650 nm, which is suitable for use with DVDs, and the DVD 10c having a thickness of 0.6 mm are used, the effective NA of the objective lens 30 is approximately 0.60. When light having a wavelength of approximately 780 nm, which is suitable for use with CDs, and the CD 10d having a thickness of approximately 1.2 mm are used, the effective NA of the objective lens 30 is approximately 0.45.

As another example, when the optical pickup is made to be compatible with the BD 10a, the DVD 10c, and the CD 10d, or for the HD DVD 10b, the DVD 10c, and the CD 10d, only one of the optical system for the DVD 10c and the optical system for the CD 10d is a finite optical system while the other is an infinite optical system.

For example, the optical system for the DVD 10c including the first optical module 51 and the collimating lens 59 is an infinite optical system in which light for the DVD 10c that is collimated by the collimating lens 59 is parallel light, and the optical system for the CD 10d including the second optical module 53 and the collimating lens 59 is a finite optical system in which that light for the CD 10d that is collimated by the collimating lens 59 may be slightly divergent light. In this case, when the BD 10a or the HD DVD 10b is employed, the active compensation device 20 transmits blue light without diffraction and diffracts red light that is suitable for use with the DVD 10c at an optimal diffraction angle according to the applied voltage. Since the optical system for CDs is a finite optical system, as noted above, when the CD 10d is employed, divergent light having an infrared wavelength is incident on the active compensation device 20, thereby making it possible to diffract the infrared light at a proper diffraction angle.

The optical path coupler 70 may be a dichroic mirror, which selectively transmits or reflects incident light according to a wavelength of the incident light. For example, the dichroic mirror may reflect blue light for use with the BD 10a and the HD DVD 10b, which is incident from the light source 11, and may transmit red light for use with the CD 10d and the DVD 10c, which is incident from the optical system 50, for low density information storage media.

The compatible optical pickup, according to an embodiment of the invention, further includes a quarter wave plate 19 interposed between the optical path changer 15 and the objective lens 30 to change the polarization of incident light. In detail, when the active compensation device 20 provides for polarization selectivity, the quarter wave plate 19 is interposed between the active compensation device 20 and the objective lens 30.

In this case, since light that is emitted from the light source 11, that is, the semiconductor laser, is mainly first linearly polarized light (e.g., S-polarized light) the linearly polarized light, incident from the light source 11, is diffracted or transmitted without diffraction by the active compensation device 20 according to the applied voltage to change a divergence angle of the light. The light passes through the quarter wave plate 19 to be rendered as first circularly polarized light, and then is focused on the information storage medium 10 by the objective lens 30. The light is reflected by the information storage medium 10 to be rendered as second circularly polarized light and passes through the quarter wave plate 19 again to be rendered as second linearly polarized light(e.g., P-polarized light), that is orthogonal to the first linearly polarized light.

When the quarter wave plate 19 is used, in an embodiment of the invention, the compatible optical pickup includes a polarization-dependent optical path changer 15 (e.g., a polarization beam splitter 13) to increase a light efficiency of the optical pickup. The polarization beam splitter 13 selectively transmits or reflects incident light according to a polarization of the incident light to transmit the linearly polarized light incident from the light source 11 to the objective lens 30 and reflect the orthogonal linearly polarized light reflected from the information storage medium 10 to the photodetector 18.

Due to the polarization optical system including the polarization beam splitter 13 and the quarter wave plate 19, light efficiency is improved during recording processes.

When the active compensation device 20 provides polarization selectivity, as described above, the quarter wave plate 19 is interposed between the active compensation device 20 and the objective lens 30. The active compensation device 20 then operated according to the polarization of light that is incident on the information storage medium 10 and according to the polarization of light reflected from the information storage medium 10. When the material layer of the active compensation device 20 is a liquid crystal layer, the active compensation device 20 includes two liquid crystal layers, which are aligned so that liquid crystals of the respective liquid crystal layers are perpendicular to each other. A first liquid crystal layer may be formed to act on first linearly polarized light (e.g., S-polarized light), that is incident on the information storage medium 10, whereas a second crystal layer may be formed to act on second linearly polarized light (e.g., P-polarized light) that is reflected from the information storage medium 10 and which is orthogonal to the first linearly polarized light.

Alternatively, in an embodiment of the invention, the active compensation device 20 includes a first active compensation unit in which the first liquid crystal layer operates according to the polarization of light incident on the information storage medium 10, and a second active compensation unit in which the second liquid crystal layer operates according to the polarization of light reflected from the information storage medium. For example, when light that is incident on the information storage medium is S-polarized light and the first active compensation unit is formed to operate on the S-polarized light, the second active compensation unit is formed to operate on P-polarized light. The first active compensation device may be disposed on an optical path between the optical path changer 15 and the quarter wave plate 19, and the second active compensation unit may be disposed in any position on the optical path between the quarter wave plate 19 and the photodetector 18. In terms of changing the polarization and the selective diffraction of light, the structure where the first and second active compensation units are used is substantially identical to the structure where the one active compensation device 20, including the two liquid crystal layers, operates according to the polarization of incident light. Since the arrangements of the active compensation units may be sufficiently understood from the description with reference to FIG. 1, a repetitive explanation and views thereof will not be given.

In an embodiment of the invention, the compatible optical pickup further includes a grating 12 to divide light that is emitted from the light source 11 into at least three light beams, and a cylinder lens 17 to help to detect a focusing error signal caused by astigmatism. An actuator 35 drives the objective lens 30 in a focus, tracking, and/or tilt direction. A monitoring photodetector 16 monitors light that is output from the light source 11.

FIG. 2 is a side sectional view of an active compensation device 1 which is applied to the compatible optical pickup according to the present invention.

As shown in FIG. 2, the active compensation device 1 includes first and second transparent substrates 2 and 7, a material layer 4 interposed between the first and second transparent substrates 2 and 7, which has a refractive index that is actively switched according to an applied voltage, and a holographic pattern 6 formed on at least one of the first and second transparent substrates 2 and 7. Transparent electrodes 3 and 8 to apply the voltage to the material layer 4 are formed on the first and second transparent substrates 2 and 7, respectively.

In an embodiment of the invention, the material layer 4 comprises an anisotropic material. This way, the refractive indices of the material layer 4 and the transparent substrate, on which the holographic pattern 6 is formed, among the first and second transparent substrates 2 and 7 may be actively switched according to an applied voltage to be equal to or different from each other with respect to incident light having a predetermined wavelength.

The material layer 4 comprises a liquid crystal layer whose refractive index is switched according to an applied voltage. When individual liquid crystals are aligned, the liquid crystal layer provides polarization selectivity. That is, when the individual liquid crystals are aligned, the refractive index of the liquid crystal layer may be switched according to an applied voltage only for light polarized in the same direction as the long-axis direction of a liquid crystal director. However, although the applied voltage is changed, a refractive index for light that is polarized in a direction perpendicular to the long-axis direction of the liquid crystal director is not changed. Accordingly, when the aligned liquid crystal layer is used as the material layer 4, the active compensation device 1 has polarization selectivity.

In another embodiment of the present invention, the individual liquid crystals of the liquid crystal layer used as the material layer 4 are not be aligned in a predetermined direction designed for polarization selectivity. That is, the liquid crystal is, for example, horizontally aligned or aligned to have a predetermined pretilt angle in a random direction. Thus, the refractive index may be switched according to an applied voltage with respect to incident light without being dependent on polarizations of the incident light.

As shown in FIGS. 2 and 4A and 4B as an example, the first transparent substrate 2, disposed on a side of the active compensation device 1 on which light is incident, may be a flat substrate and the holographic pattern 6 may be formed on the second transparent substrate 7, which is disposed on a side of the active compensation device 1 from which light is emitted. The transparent substrate on which the holographic pattern 6 is formed is referred to as a holographic substrate 5.

The holographic pattern 6 is formed on a surface of the second transparent substrate 7 adjacent to the material layer 4 to change a divergence angle of light by diffracting or transmitting incident light, without diffracting the incident light, according to a conversion of the refractive index of the material layer 4.

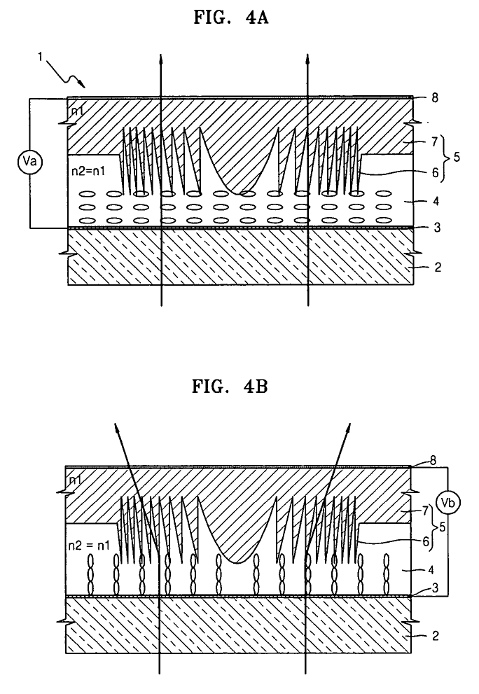

FIG. 3 is a plan view of the holographic pattern 6 of the active compensation device 1 of FIG. 2. Referring to FIG. 3, horizontal and vertical axes represent radial ranges (mm) of the holographic pattern 6 and a radius of 1.5 mm may correspond to the radial range of the objective lens 30 corresponding to an NA of 0.85 as will be described later.

As shown in FIGS. 2 and 3, the holographic pattern 6 is, in an embodiment of the invention, formed to produce a phase distribution that is proportional to the square of a radius from the center of the holographic pattern 6. The holographic pattern 6 is obtained by assigning a value only to C2 and no values to other coefficients among holographic optical element (HOE) phase coefficients in a rotationally symmetric form. The holographic pattern 6 may be modified according to design values of the hologram coefficients with consideration given to design values of other optical elements of an optical system to which the active compensation device 1 is applied.

The holographic pattern 6 may be formed as follows. For example, after the holographic substrate 5, including the second transparent substrate 7 and the holographic pattern 6 that produces the phase distribution proportional to the square of the radius as shown in FIGS. 2 and 3, is manufactured, the transparent electrode 8 made of indium tin oxide (ITO) is formed. The transparent electrode 8 may be formed on the opposite surface of the holographic substrate 5 to the surface on which the holographic pattern 6 is formed. Alternatively, the transparent electrode 8 may be formed on the very surface of the holographic substrate 5 on which the holographic pattern 6 is formed.

The flat transparent substrate 2 made of glass and formed with the transparent electrode 3 thereon is prepared. An anisotropic material such as a liquid crystal is sealed between the flat transparent substrate 2 and the holographic substrate 5 to form the material layer 4, thereby completing the active compensation device 1 as shown in FIG. 2.

FIGS. 4A and 4B illustrate the operating principle of the active compensation device 1 of FIG. 2.

As shown in FIG. 4A, when a voltage Va is applied to the active compensation device 1 so that the refractive index n1 of the holographic substrate 5 and the refractive index n2 of the liquid crystal are made to be equal to each other, incident light is transmitted without being diffracted. However, as shown in FIG. 4B, when a voltage Vb is applied so that the refractive index n1 of the holographic substrate 5 is different from the refractive index n2′ of the liquid crystal material, incident light is diffracted by the holographic pattern 6 of the holographic substrate 5. Accordingly, the divergence angle of the incident light is switched such that the light is collimated, converged, or diverged. The voltages Va and Vb may vary according to whether the liquid crystal has a positive or negative refractive index anisotropy, or whether the liquid crystal is aligned horizontally or vertically. Also, the voltage Vb may be adjusted according to the wavelength of incident light and according to whether the information storage medium is the HD DVD 10b, the DVD 10c, or the CD 10d.

FIGS. 4A and 4B respectively illustrate cases where parallel light incident on the active compensation device 1 is transmitted without diffraction and diffracted into first order light to be divergent light.

Diffraction efficiency is related with a difference between the refractive indices of the holographic substrate 5 and the liquid crystal, the depth of the holographic pattern 6, and the wavelength of incident light. Accordingly, the active compensation device 1 may satisfy the condition in which, when a difference between the refractive index n1 of the holographic substrate 5 and the refractive index n2 of the liquid crystal material is Δn=n1−n2, the depth of the holographic pattern 6 is d, the wavelength of incident light is λ, and the order of diffracted light is m, the active compensation device 1 may be given by
(Δn·λ−1)d=m·λ (2)

When the active compensation device 1 satisfies Equation 2, diffraction efficiency is almost 100%.

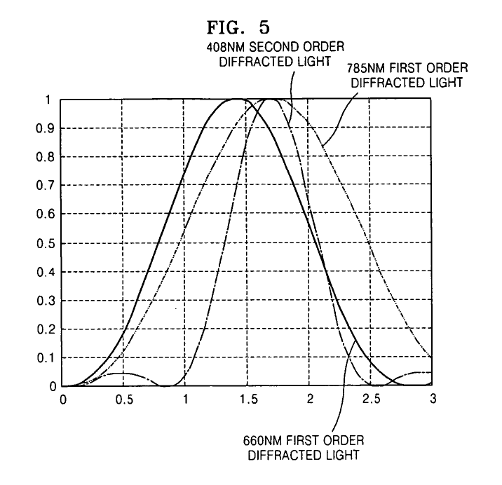

When the orientation of the liquid crystal is adjusted according to an applied voltage based on this principle, an effect in which the depth of the holographic pattern is varied with respect to the wavelength of the incident light is obtained. Accordingly, as shown in FIG. 5, maximum diffraction efficiency at each required wavelength is obtained. FIG. 5 illustrates the diffraction efficiency at wavelengths of 408 nm, 785 nm, and 660 nm according to the depth of the holographic pattern when the hologram element comprises silica. As shown, the diffraction efficiency at the wavelength of 408 nm results from second order diffracted light, the diffraction efficiency at the wavelength of 660 nm results from first order diffracted light, and the diffraction efficiency at the wavelength of 785 nm results from first order diffracted light.

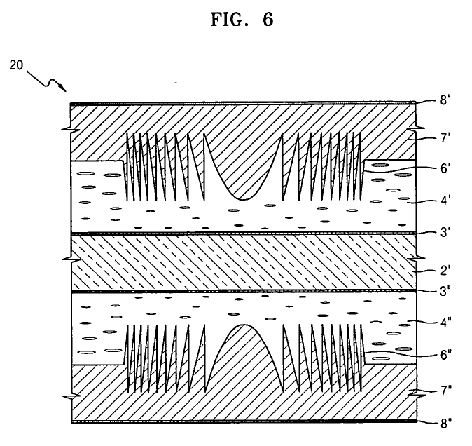

FIG. 6 is a sectional view of another embodiment of an active compensation device 20 which is applied to the compatible optical pickup of FIG. 1. As shown in FIG. 6, the active compensation device 20 includes two material layers 4′ and 4″ which only act on a polarization state of light that is incident on the information storage medium 10 and a polarization state of light that is reflected therefrom, respectively.

Further, as shown in FIG. 6, the active compensation device 20 includes first through third transparent substrates 2′, 7′, and 7″, the first and second material layers 4′ and 4″ respectively interposed between the first and second transparent substrates 2′ and 7′, between the first and third transparent substrates 2′ and 7″, and having refractive indices which are actively switched according to applied voltages, and first and second holographic patterns 6′ and 6″ respectively formed on surfaces of the second and third transparent substrates 7′ and 7″ in positions adjacent to the first and second material layers 4′ and 4″. Transparent electrodes 3′, 3″, 8′, and 8″ to apply voltages to the first and second material layers 4′ and 4″ are also formed on the first through third substrates 2′, 7′, and 7″.

Since the transparent substrates 2′, 7′, and 7″, the material layers 4′ and 4″, the holographic patterns 6′ and 6″, and the transparent electrodes 3′, 3″, 8′, and 8″ are substantially identical or similar to the like elements of the active compensation device 1 described with respect to FIGS. 2 and 4 in terms of their structures and functions, a detailed description thereof will not be given.

Although the first and second holographic patterns 6′ and 6″ have the same shapes in FIG. 6, the shapes of the first and second holographic patterns 6′ and 6″ may vary. Further, although the second and third holographic patterns 6′ and 6″ are formed on the inner surfaces of the outer second and third transparent substrates 7′ and 7″ in FIG. 6, the first and second holographic patterns 6′ and 6″ may also be formed on both surfaces of the intermediate first transparent substrate 2′. Alternatively, any one of the first and second holographic patterns 6′ and 6″ may be formed on the first transparent substrate 2′, and the other holographic pattern 6′ or 6″ may be formed on the second or third transparent substrate 7′ or 7″.

Although the active compensation device 20 uses the three transparent substrates 2′, 7′, and 7″ in FIG. 6, two transparent substrates may be used without the intermediate first transparent substrate 2′ to form a structure in which two active compensation devices 1 described with reference to FIGS. 2 through 4 are combined.

Even though the active compensation device 20 is constructed as shown in FIG. 6, the first and second holographic patterns 6′ and 6″ respectively adjacent to the first and second material layers 4′ and 4″ are formed to satisfy Equation 1.

Here, it is assumed that the first material layer 4′ acts on first linearly polarized light propagating toward the information storage medium 10 and the second material layer 4″ acts on second linearly polarized light which is orthogonal to the first linearly polarized light by reflected by the information storage medium 10 and transmitted through the quarter wave plate 19. In this case, when a proper voltage is applied to achieve maximum diffraction efficiency for light having a predetermined wavelength, the refractive index of the fist material layer 4′ is switched, such that the refractive indices of the first material layer 4′ and the second transparent substrate 7′, on which the first holographic pattern 6′ is formed, are different from each other. As a result, the light propagating toward the information storage medium 10 is diffracted by the first holographic pattern 6′ to be divergent at a predetermined divergence angle. Accordingly, when reproducing or recording an information storage medium having a thickness different from the optimal thickness for which the objective lens 30 is designed, for example, the HD DVD 10b, the DVD 10c, or the CD 10D, spherical aberration caused by the thickness difference may be corrected.

While the light that is travelling toward the information storage medium 10 is diffracted by the holographic pattern 6′ and is deemed to be divergent when incident on the objective lens 30, the light that is reflected by the information storage medium 10 and which proceeds through the objective lens 30 toward the active compensation device 20 is deemed to be convergent. When a proper voltage is applied to the second material layer 4″ of the active compensation device 20, the refractive index of the second material layer 4″ is switched such that the refractive indices of the second material layer 4″ and the third transparent substrate 7″, on which the second holographic pattern 6″ is formed, are different from each other. When the second material layer 4″ and the second holographic pattern 6″ are substantially identical to the first material layer 4′ and the first holographic pattern 6′, the voltages applied to the first and second material layers 4′ and 4′ may be identical. Due to the difference in the refractive indices, the light reflected by the information storage medium 10 is diffracted by the second holographic pattern 6″ to have the same convergence angle as the divergence angle of the light incident on the active compensation device 20 from the light source 11 or the optical system 50 for low density information storage media. That is, the light reflected by the information storage medium 10 becomes parallel or slightly convergent to travel along the same optical path. Accordingly, high-quality reproduction and error signals may be detected.

Table 1 illustrates design data for the objective lens 30 and the active compensation device 20 which are employed by the compatible optical pickup of FIG. 1 to be compatible for the BD 10A, the HD DVD 10b, the DVD 10c and the CD 10d. As shown in Table 1, the objective lens 30 and the active compensation device 20 are designed in accordance with the conditions summarized in Table 2. That is, in the case of the BD 10a having a thickness of 0.1 mm, a voltage V1 is applied to the active compensation device 20 so that the active compensation device 20 transmits blue light having a wavelength of 408 nm without diffraction as zero^{th} order light, and the objective lens 30 for the zero^{th} order light, which passes through the active compensation device 20, has an NA of 0.85 and a focal length of 2.35 mm.

In the case of the HD DVD 10b having a thickness of 0.6 mm, a voltage V2 is applied to the active compensation device 20 so that the active compensation device 20 diffracts light having a wavelength of 408 nm into second order light to change an angle of incidence of light on the objective lens 30, and the objective lens for the second order light has an NA of 0.65 and a focal length of 2.35 mm.

In the case of the DVD 10c having a thickness of 0.6 mm, a voltage V3 is applied to the active compensation device 20 so that the active compensation device 20 diffracts slightly divergent light having a wavelength of 660 nm into first order light to change an angle of incidence of light on the objective lens 30, and the objective lens 30 for the first order light has an NA of 0.65 and a focal length of 2.45 mm.

In the case of the CD 10d having a thickness of 1.2 mm, a voltage V4 is applied to the active compensation device 20 so that the active compensation device 20 can diffract divergent light having a wavelength of 785 nm into first order light to change an angle of incidence of light on the objective lens 30, and the objective lens 30 for the first order light can have an NA of 0.47 and a focal length of 2.47 mm.

As shown in Table 2, designing data of Table 1 indicates that the optical system for the BD 10a and HD DVD 10b is an infinite optical system and the optical system for the DVD 10c and the CD 10d is a finite optical system.

TABLE 1

| Surface | Radius of curvature | Thickness | Glass |
|---|---|---|---|
| Object | INFINITY | INFINlTY_{z} | |
| plane | | | |
| S1 | INFINITY | 0.000000 | |
| S2 | INFINITY | 0.400000 | Silica |
| S3 | INFINITY | 0.500000 | Silica |
| S4 | INFINITY | 0.400000 | Silica |
| HOE | C1; 9.3448E−04 C2; −4.2861E−04 C3; 4.8444E−05 C4; | | |
| | −5.9679E−05 C5; 1.0353E−05 | | |
| S5 | INFINITY | 0.000000 | |
| S6 | INFINITY | 2.000000 | |
| S7 STOP | INFINITY | 0.000000 | |
| S8 | 1.838415 | 2.860000 | LaF2_HOYA |
| (Aspherical | K; −0.709697 A; 0.668561E−02 B; 0.261545E−03 C; | | |
| surface) | 0.568568E−03 D; −.346785E−03 E; 0.154228E−03 F; | | |
| | −.342724E−04 G; 0.774357E−06 H; | | |
| | 0.107781E−05 J; −.157659E−06 | | |
| S9 | −44.985401 | 0.000000 | |
| (Aspherical | K; −42932.44 A; 0.760031E−01 B; −.813015E−01 C; | | |
| surface) | 0.414602E−01 D; −.119043E−01 E; 0.599040E−03 F; | | |
| | 0.420413E−03 G; 0.258764E−14 H; −.653282E−14 | | |
| | J; −.903077E−15 | | |
| S10 | INFINITY | 0.695227_{z} | |
| S11 | INFINITY | 0.100000_{z} | ‘CG’ |
| S12 | INFINITY | 0.000000 | |
| Image | INFINITY | 0.000000 | |
| plane | | | |

TABLE 2

| | | Disc | | | |
|---|---|---|---|---|---|
| | | BD | HD DVD | DVD | CD |
| Wavelength | | 408 nm | 408 nm | 660 nm | 785 nm |
| Refractive index | Silica | 1.469275 | 1.469275 | 1.456538 | 1.453582 |
| | KaF2_HOYA | 1.772138 | 1.772138 | 1.738822 | 1.732911 |
| | ‘CG’ | 1.62 | 1.62 | 1.58 | 1.57 |
| NA | | 0.85 | 0.65 | 0.65 | 0.47 |
| Focal length | | 2.35 mm | 2.35 mm | 2.45 mm | 2.47 mm |
| Hologram diffraction | S4 | Zeroth order | Second | First order | First order |
| order | | (V1) | order (V2) | (V3) | (V4) |
| Thickness | Object plane | INFINITY | INFINITY | 193.67666 | 36.30670 |
| | S10 | 0.695 mm | 0.407 mm | 0.500 mm | 0.275 mm |
| | S15 | 0.1 mm | 0.6 mm | 0.6 mm | 1.2 mm |
| | (Substrate | | | | |
| | thickness) | | | | |

The reason why the holographic pattern is formed on only one surface S4, as shown in Table 1, will now be explained. When the active compensation device 20 includes the two material layers 4′ and 4″ and the holographic patterns 6′ and 6″ that are formed adjacent to the two material layers 4′ and 4″ on the surfaces of the transparent substrates 7′ and 7″ as shown in FIG. 6, the two material layers 4′ and 4″ respectively act with respect to lights having orthogonal polarizations.

Accordingly, light propagating toward the information storage medium 10 is affected by one of the two holographic patterns 6′ and 6″, and light reflected by the information storage medium 10 is affected by the other of the two holographic patterns 6′ and 6″. Accordingly, the light propagating toward the information storage medium 10 and the light reflected by the information storage medium 10 is substantially affected in both cases by only one holographic pattern on the respective optical paths.

Table 1 illustrates that the holographic pattern affecting the light that propagates toward the information storage medium 10 is formed on the surface S4 of the transparent substrate. In contrast, the holographic pattern that affects the light reflected by the information storage medium 10 may be formed on surfaces S2 or S3 of the other transparent substrate. That is, when the light propagating toward the information storage medium and the light reflected by the information storage medium 10 are compared, only the position on the surface, on which the holographic pattern is formed, is different.

Referring to Tables 1 and 2, when the BD 10a is adopted for use, the active compensation device 20 is operated to transmit parallel light having a blue wavelength as zero^{th} order light therethrough. When the HD DVD 10b is adopted for use, the active compensation device 20 is operated to diffract parallel light having a blue wavelength into second order light. When the DVD 10c or the CD 10d is adopted for use, the active compensation device 20 is operated to diffract divergent light having a red wavelength or an infrared wavelength into first order light. Since the material layer 4 is much thinner than the transparent substrate, consideration need not be given to the thickness of the material layer 4 is not considered at the design stage.

The surface S4 in Table 4 on which the holographic pattern that affects the light propagating toward the information storage medium 10 is formed contacts the material layer 4. C1, C2, C3, and C4 each denote hologram coefficients.

S8 and S9 in Table 1 denote aspherical lens surfaces of the objective lens 30, K denotes a conic coefficient in the equation of an aspherical surface, and A, B, C, D, E, F, G, H, and J each denote aspherical coefficients.

In rotationally symmetric form, the HOE phase coefficients are given by

$$φ = \frac{2 π}{{λ}_{0}} {\sum }_{n} {C}_{n} {r}^{2 n} \qquad ( 3 )$$

where Cn denotes a hologram coefficient, r denotes a radius of curvature, λ₀ denotes a wavelength, and Φ denotes a phase.

As shown in Table 1, both the lens surfaces of the objective lens 30 are aspherical. When a depth from the vertex of an aspherical surface is z, the equation of the two aspherical surfaces of the objective lens 30 is given by

$$z = \frac{{ch}^{2}}{1 + \sqrt{1 - ( 1 + K ) {c}^{2} {h}^{2}}} + A {h}^{4} + B {h}^{6} + {Ch}^{8} + {Dh}^{10} + {Eh}^{12} + {Fh}^{14} + {Gh}^{16} + {Hh}^{18} + {Jh}^{20} \qquad ( 4 )$$

where h denotes a height from an optical axis, c denotes a curvature, K denotes a conic coefficient, and A through J each denote aspherical coefficients.

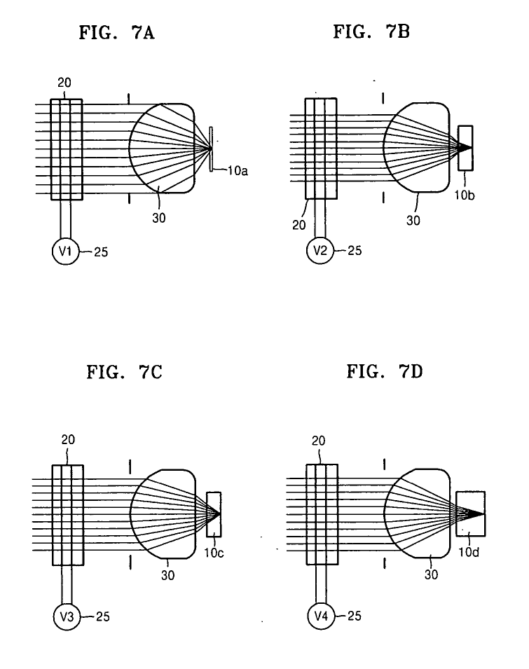

FIGS. 7A through 7D illustrate optical paths of light when the objective lens 30 and the active compensation device 20, designed with the data of Tables 1 and 2, are used. FIG. 7A illustrates a case where a voltage V1 is applied to the active compensation device 20 such that incident light having a wavelength of 408 nm is transmitted without diffraction to be focused on the BD 10a. FIG. 7B illustrates a case where a voltage V2 is applied to the active compensation device 20 such that incident light having a wavelength of 408 nm is diffracted into second order light by the active compensation device 20 to be focused on the HD DVD 10b, thereby correcting for spherical aberration resulting from the difference between the thickness of the HD DVD 10b and the optical disc thickness for which the objective lens 30 is designed. FIG. 7C illustrates a case where a voltage V3 is applied to the active compensation device 20 such that incident divergent red light having a wavelength of 660 nm is diffracted into first order light by the active compensation device 20 to be focused on the DVD 10c, thereby correcting for spherical aberration resulting from the thickness of the DVD 10c and the optical disc thickness for which the objective lens 30 is designed. FIG. 7D illustrates a case where a voltage V4 is applied to the active compensation device 20 such that incident divergent light having an infrared wavelength of 785 nm is diffracted into first order light by the active compensation device 20 to be focused on the CD 10d, thereby correcting for spherical aberration resulting from the difference between the thickness of the CD 10d and the optical disc thickness for which the objective lens 30 is designed.

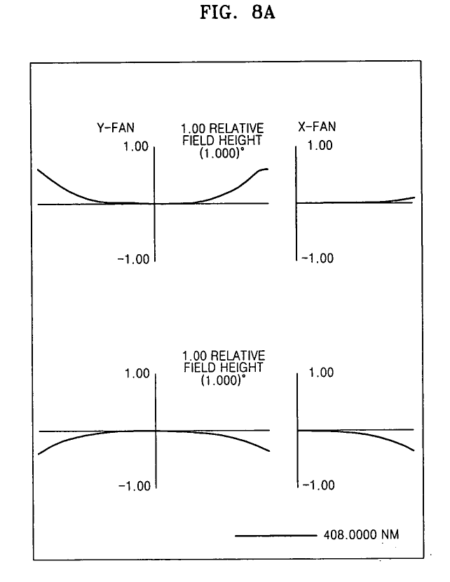

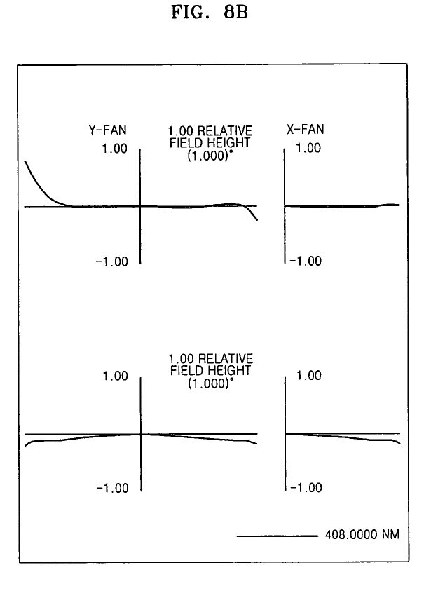

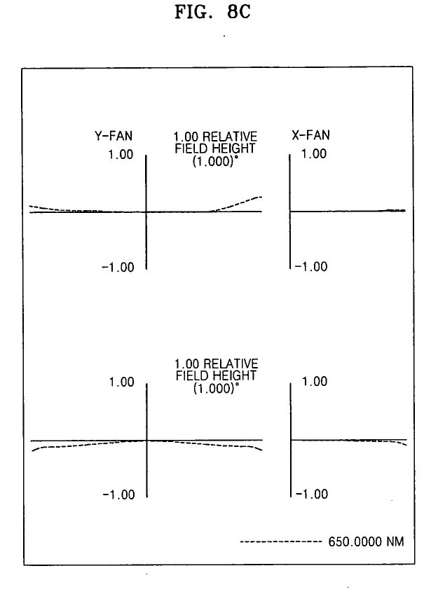

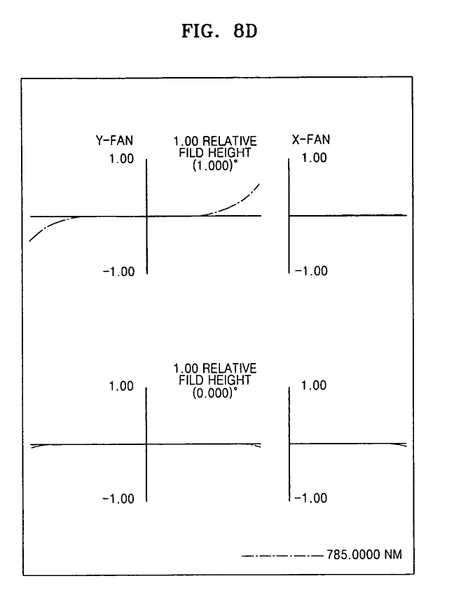

FIGS. 8A through 8D respectively illustrate spherical aberration when the active compensation device 20 and the objective lens 30, designed based on the data of Tables 1 and 2, are configured to form the optical paths of FIGS. 7A through 7D when the BD 10a, the HD DVD 10b, the DVD 10c, and the CD 10d are adopted for use. As shown in FIGS. 8A through 8D, since the optical pickup, including the active compensation device 20 and the objective lens 30, has excellent aberration compensation with respect to the BD 10a, the HD DVD 10b, the DVD 10c, and the CD 10d, the optical pickup may be compatible with the BD 10a, the HD DVD 10b, the DVD 10c, and the CD 10d.

Although the active compensation device 20 and the objective lens 30 are compatible with the BD 10a, the HD DVD 10b, the DVD 10c, and the CD 10d in the above embodiment, it is, of course, understood that the active compensation device 20 and the objective lens 30 of the compatible optical pickup of the present embodiment may be formed to be compatible with the DVD 10c, the CD 10d, and any one of the BD 10a and the HD DVD 10b.

Table 3 illustrates different design data for the objective lens 30 and the active compensation device 20. The compatible optical pickup that employs the objective lens 30 and the active compensation device 20, designed with the data of Table 3 may be compatible with the BD 10a, the DVD 10c, and the CD 10d.

As shown in Table 3, the objective lens 30 and the active compensation device 20 are designed with the conditions summarized in Table 4 in mind. That is, in the case of the BD 10a having a thickness of 0.1 mm, a voltage V1 is applied to the active compensation device 20 so that the active compensation device 20 transmits blue light having a wavelength of 408 nm therethrough without diffraction as zero^{th} order light. There, the objective lens 30 has an NA of 0.85 and a focal length of 2.35 mm. In the case of the DVD 10c having a thickness of 0.6 mm, a voltage V3 is applied to the active compensation device 20 so that the active compensation device 20 diffracts parallel light having a wavelength of 660 nm into first order light to change an angle of incidence of light on the objective lens 30. There, the objective lens 30 has an NA of 0.65 and a focal length of 2.45 mm. Also, in the case of the CD 10d having a thickness of 1.2 mm, a voltage V4 is applied to the active compensation device 20 so that the active compensation device 20 diffracts divergent light having a wavelength of 785 nm into first order light to change an angle of incidence of light on the objective lens 30. There, the objective lens 30 can have an NA of 0.47 and a focal length of 2.47 mm. As shown in Table 4, the designing data of Table 3 indicates that the optical system for the BD 10a and HD DVD 10b is an infinite optical system where the location of the object plane is infinite and the optical system for the CD 10d is a finite optical system where the location of the object plane is finite.

TABLE 3

| Surface | Radius of curvature | Thickness | Glass |
|---|---|---|---|
| Object plane | INFINITY | INFINITY_{z} | |
| S1 | INFINITY | 0.000000 | |
| S2 | INFINITY | 0.400000 | Silica |
| S3 | INFINITY | 0.500000 | Silica |
| S4 HOE | INFINITY | 0.400000 | Silica |
| | C1; 3.5092E−04 C2; −4.9001E−04 C3; −3.7623E−06 | | |
| | C4; −4.2575E−05 C5; 8.8277E−06 | | |
| S5 | INFINITY | 0.000000 | |
| S6 | INFINITY | 2.000000 | |
| S7 STOP | INFINITY | 0.000000 | |
| S8 | 1.838415 | 2.860000 | LaF2_HOYA |
| (Aspherical | K; −0.709697 A; 0.668561E−02 B; 0.261545E−03 | | |
| surface) | C; 0.568568E−03 D; −.346785E−03 E; 0.154228E−03 | | |
| | F; −.342724E−04 G; 0.774357E−06 H; 0.107781E−05 | | |
| | J; −.157659E−06 | | |
| S9 | −44.985401 | 0.000000 | |
| (Asphencal | K; −42982.44 A; 0.760031E−01 B; −.813015E−01 | | |
| surface) | C; 0.414602E−01 D; −.119043E−01 E; 0.599040E−03 | | |
| | F; 0.420413E−03 G; 0.258764E−14 H; −.653282E−14 | | |
| | J; −.903077E−15 | | |
| S10 | INFINITY | 0.695227_{z} | |
| S11 | INFINITY | 0.100000_{z} | ‘CG’ |
| S12 | INFINITY | 0.000000 | |
| Image pane | INFINITY | 0.000000 | |

TABLE 4

| | | Disc | | |
|---|---|---|---|---|
| | | BD | DVD | CD |
| Wavelength | | 408 nm | 660 nm | 785 nm |
| Refractive | Silica | 1.469275 | 1.456538 | 1.453582 |
| index | LaF2_HOYA | 1.772138 | 1.738822 | 1.732911 |
| | ‘CG’ | 1.62 | 1.58 | 1.57 |
| NA | | 0.85 | 0.65 | 0.47 |
| Focal length | | 2.35 mm | 2.45 mm | 2.47 mm |
| Hologram | S4 | Zeroth order | First order | First order (V4) |
| diffraction | | (V1) | (V3) | |
| order | | | | |
| Thickness | Object plane | INFINITY | INFINITY | 40.78044 |
| | S10 | 0.695 mm | 0.457 mm | 0.242 mm |
| | S15 (Substrate | 0.1 mm | 0.6 mm | 1.2 mm |
| | thickness) | | | |

The reason why the holographic pattern is formed on only one surface S4 in Table 3 is the same as described with reference to Table 1.

Referring to Tables 3 and 4, when the BD 10a is adopted for use, the active compensation device 20 transmits parallel light having a blue wavelength as zero^{th} order light. When the DVD 10c is adopted for use, the active compensation device 20 diffracts parallel light having a red wavelength into first order light. When the CD 10d is adopted for use, the active compensation device 20 diffracts divergent light having an infrared wavelength into first order light. Since the material layer, whose refractive index is switched, is much thinner than the transparent substrate, consideration need not be given to the thickness of the material layer at the design stage.

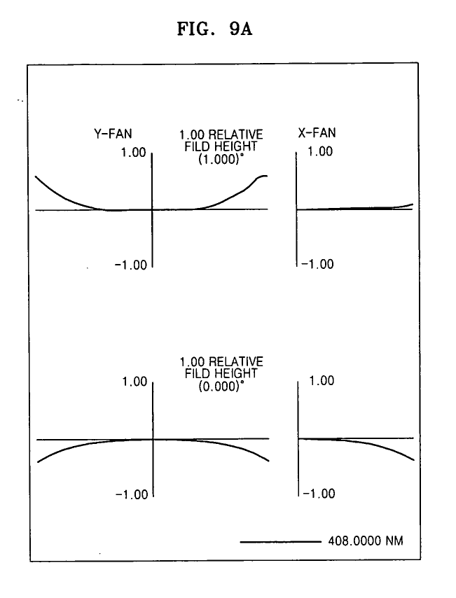

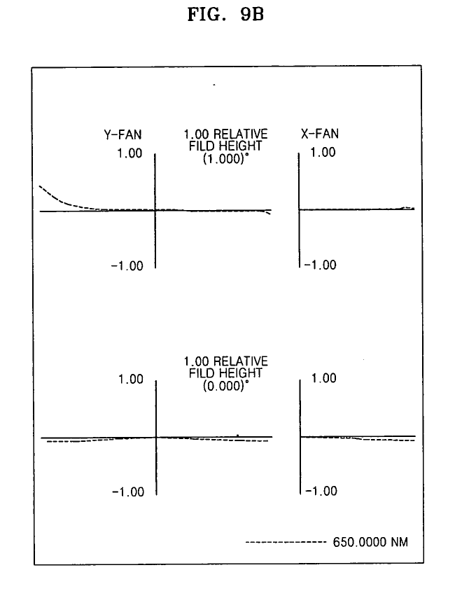

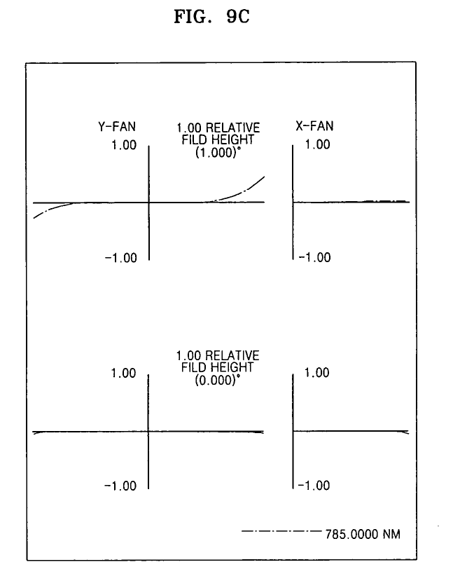

FIGS. 9A through 9C respectively illustrate spherical aberration with respect to the BD 10a, the DVD 10c, and the CD 10d when a voltage that is applied to the active compensation device 20, designed based on the data of Tables 3 and 4, is adjusted according to the disc. Referring to FIGS. 9A through 9C, since the optical pickup that employs the active compensation device 20 and the objective lens 30, designed based on the data of Tables 3 and 4, has excellent aberration correction with respect to the BD 10a, the DVD 10c, and the CD 10d, the optical pickup may be compatible with the BD 10a, the DVD 10c, and the CD 10d.

In another embodiment of the present invention, the active compensation device 20 and the objective lens 30 are compatible with the HD DVD 10b, the DVD 10c, and the CD 10d. In this case, when the HD DVD 10b is adopted for use, the active compensation device 20 transmits parallel light having a blue wavelength as zero^{th} order light; when the DVD 10c is adopted for use, the active compensation device 20 diffracts parallel light having a red wavelength into first order light; and when the CD 10d is adopted for use, the active compensation device 20 diffracts divergent light having an infrared wavelength into first order light. Thus, the compatible optical pickup may be compatible with the HD DVD 10b, the DVD 10c, and the CD 10d.

According to the compatible optical pickup of the present embodiment, when an information storage medium having a thickness that is different from the thickness for which the objective lens 30 is designed, an angle of light that is incident on the objective lens 30 is adjusted by one of the holographic patterns of the active compensation device 20 so as to correct for spherical aberration that results from the thickness difference to form an optimal light spot on the information storage medium 10.

Also, light that is reflected by the information storage medium 10 and incident as convergent light on the active compensation device 20 is diffracted by the other holographic pattern to have a convergence angle, which is substantially equal to the divergence angle of light emitted from the light source 11 and the optical system 50 for low density information storage media. As such, detecting high-quality reproduction and error signals is possible.

Although the compatible optical pickup includes the two material layers whose refractive indices may be respectively switched according to the polarized light propagating toward the information storage medium 10 and the orthogonally polarized light reflected by the information storage medium 10, and one or two separated active compensation devices having a holographic pattern formed adjacent to each of the material layers on the surface of the transparent layers, the optical pickup according to aspects of the present invention may include only one active compensation device having no polarization selectivity.

FIG. 10 illustrates a compatible optical pickup according to another embodiment of the present invention. Except for an active compensation device 120 having no polarization selectivity, the optical pickup of FIG. 10 is identical or similar to the compatible optical pickup of FIG. 1. Like elements are denoted by like reference numerals, and a repetitive explanation thereof will not be given.

As shown in FIG. 10, the active compensation device 120 includes one material layer. However, the refractive index of the material layer may be switched for all incident light regardless of the polarization. For example, the material layer may be a liquid crystal layer and the liquid crystal layer may be aligned in random direction, that will allow the switching of the refractive index of the material layer for all incident light according to an applied voltage regardless of the polarization. That is, the liquid crystal may be horizontally aligned or aligned with a predetermined pre-tilt angle in random direction. In this case, when a predetermined voltage is applied so that the refractive indices of the material layer and the transparent substrate are different from each other, first polarized light (e.g., P-polarized light) that is directed toward the information storage medium 10 passes through the material layer to be diffracted by the holographic pattern due to the difference between the refractive indices of the material layer and the transparent substrate. Accordingly, an angle of incidence of light on the objective lens 30 is changed to correct for spherical aberration. Second polarized light (e.g., S-polarized light) that is reflected by the information storage medium 10 passes through the material layer to be diffracted to change a divergence angle, thereby compensating for a divergence angle generated for compensation of spherical aberration. Accordingly, high-quality reproduction and error signals are detectable.

When the active compensation device 120 has no polarization selectivity, the quarter wave plate 19 need not be interposed between the active compensation device 120 and the objective lens 30, and may be disposed at any position along the optical path between the polarization beam splitter 13 and the objective lens 30.

The compatible optical pickup according to the present embodiment may also use a beam splitter, which transmits and reflects incident light at a predetermined ratio, instead of the polarization optical system that combines the polarization beam splitter 13 and the quarter wave plate 19.

As is described above, the compatible optical pickup is compatible with three or more information storage medium standards using one objective lens. The compatible optical pickup maximizes diffraction efficiency at each wavelength, and hence, increases luminous efficiency because of the holographic pattern having a predetermined depth between the two transparent substrates to correct aberration caused by a difference in different information storage medium standards. Since a complex electrode structure to produce a phase difference necessary for each information storage medium standard is not required, the structure of the active compensation device is simpler than the structure of a conventional active compensation device.

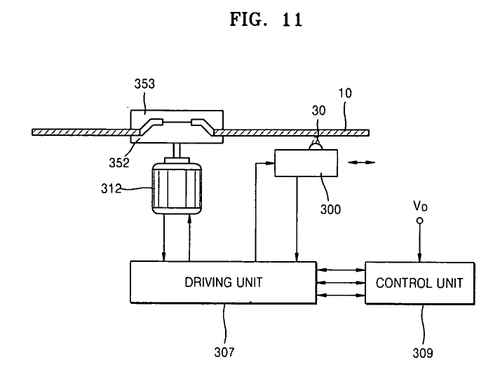

FIG. 11 illustrates an optical recording and/or reproducing apparatus employing a compatible optical pickup according to the present invention. As shown in FIG. 11, the optical recording and/or reproducing apparatus includes a spindle motor 312 to rotate the information storage medium 10, an optical pickup 300 movable in a radial direction of the information storage medium 10 to record and/or reproduce information to and/or from the information storage medium 10, a driving unit 307 to drive the spindle motor 312 and the optical pickup 300, and a control unit 309 to control focus, tracking, and/or tilt servos of the optical pickup 300. Reference numeral 352 denotes a turntable, and reference numeral 353 denotes a clamp chucking the information storage medium.

The optical pickup 300 has an optical system according to any one of various embodiments of the present invention.

Light reflected by the optical disc 10 is detected by the photodetector of the optical pickup 300 to be converted into an electric signal. The electric signal is input through the driving unit 307 to the control unit 309. The driving unit 307 controls the rotation speed of the spindle motor 312, amplifies an input signal, and drives the optical pickup 300. The control unit 309 provides a focus servo, a tracking servo, and/or a tilt servo command that is adjusted based on the signal that is re-input from the driving unit 307 to the driving unit 307 so as to enable the optical pickup 300 to perform a focusing, tracking, and/or tilting operation. The optical recording and/or reproducing apparatus employing the compatible optical pickup 300 may be compatible with at least one of the BD 10a and the HD DVD 10b, and at least one of the DVD 10c and the CD 10d, and maximizes the amount of light directed toward the information storage medium 10 without a substantially light loss by usage of the active compensation device 20, thereby ensuring a relatively high luminous efficiency. Since the optical recording and/or reproducing apparatus uses only one objective lens 30, as opposed to a conventional actuator including one lens holder and two or more objective lenses, high speed operation is achieved.

The compatible optical pickup according to aspects of the present invention is compatible with three or more information storage medium standards using one objective lens. Moreover, since the compatible optical pickup maximizes diffraction efficiency at each wavelength by adjusting the voltage applied to the material layer of the active compensation device, which includes the material layer whose refractive index is switchable and the holographic pattern formed on at least one surface of the transparent substrate adjacent to the material layer, luminous efficiency is improved. Accordingly, since a complex electrode structure for forming a phase difference necessary for each information storage medium is not required, the structure of the active compensation device is simplified.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A compatible optical pickup comprising:
a light source to emit light;
an objective lens that focuses the light to be incident on information storage media and which is optimized for use with a first information storage medium to which the light emitted from the light source is irradiated;
a first optical system to emit light suitable for use with a second information storage medium, the first optical system being configured as a finite optical system; and
an active compensation device to actively switch an angle of incidence of the light on the objective lens when either a third information storage medium that has a different format from that of the first and second information storage media, or the second information storage medium is adopted for use in a data recording/reproducing operation,
wherein the active compensation device comprises:
a plurality of transparent substrates; and
at least one material layer, interposed between the plurality of substrates, having a refractive index which is actively switched according to an applied voltage,
wherein a holographic pattern, formed adjacent to the material layer on a surface of at least one of the transparent substrates, changes a divergence angle of the light by diffracting or transmitting without diffraction the incident light according to a change of the refractive index of the material layer, and
wherein the voltage applied to the material layer is adjusted according to the applied information storage medium that is adopted for the use in the data recording/reproducing operation.

2. The compatible optical pickup according to claim 1, wherein the first and third information storage media are respectively a blu-ray disc (BD) and a high-definition digital versatile disc (HD DVD) or vice versa, and the second information storage medium is at least one of a digital versatile disc (DVD) and a compact disc (CD), and wherein the first optical system emits the light suitable to record or reproduce information on at least one of the DVD and the CD.

3. The compatible optical pickup according to claim 2, wherein the wavelength of the light emitted by the light source is approximately 400 nm, a thickness of the first information storage medium is approximately 0.1 mm, and an effective numerical aperture of the objective lens for the first information storage medium is approximately 0.85;
a wavelength of the light suitable for use with the DVD is approximately 650 nm, a thickness of the DVD is approximately 0.6 mm, and an effective numerical aperture of the objective lens for the DVD is approximately 0.60;
a wavelength of the light suitable for use with the CD is approximately 780 nm, a thickness of the CD is approximately 1.2 mm, and an effective numerical aperture of the objective lens for the CD is approximately 0.45; and
a thickness of the third information storage medium is approximately 0.6 mm and the effective numerical aperture of the objective lens for the third information storage medium is approximately 0.65.

4. The compatible optical pickup according to claim 2, further comprising:
an optical path changer, interposed between the light source and the objective lens, to change an optical path of the light;
a photodetector to receive light that is reflected by the first information storage medium and which passes through the objective lens and the optical path changer; and
an optical path coupler to couple an optical path of light emitted from the first optical system to an optical path of light emitted from the light source so that the light emitted from the first optical system is directed toward the objective lens.

5. The compatible optical pickup according to claim 1, further comprising a second optical system to emit light to record and/or reproduce information onto/from the third information storage medium, wherein the first information storage medium is any one of a BD and a HD DVD, and the second and third information storage media are, respectively, a DVD and a CD or vice versa.

6. The compatible optical pickup according to claim 5, wherein the second optical system comprises an infinite optical system.

7. The compatible optical pickup according to claim 5, wherein a wavelength of the light emitted by the light source is approximately 400 nm, a thickness of the first information storage medium, and an effective numerical aperture of the objective lens for the first information storage medium are approximately 0.1 mm and 0.85, respectively, or 0.6 mm and 0.65, respectively;
a wavelength of the light suitable for use with the DVD is approximately 650 nm, a thickness of the DVD is approximately 0.6 mm, and an effective numerical aperture of the objective lens for the DVD is approximately 0.60; and
a wavelength of the light suitable for use with the CD is approximately 780 nm, a thickness of the CD is approximately 1.2 mm, and an effective numerical aperture of the objective lens for the CD is approximately 0.45.

8. The compatible optical pickup according to claim 5, further comprising:
an optical path changer, interposed between the light source and the objective lens, to change an optical path of the light;
a photodetector to receive light that is reflected by the first information storage medium and which passes through the objective lens and the optical path changer; and
an optical path coupler to couple optical paths of light emitted from the first and second optical systems to an optical path of the light emitted from the light source so that the light emitted from the first and second optical systems is directed toward the objective lens.

9. The compatible optical pickup according to claim 1, wherein the light source emits light having a wavelength of approximately 400 nm.

10. The compatible optical pickup according to claim 1, wherein, when a difference between the refractive indices of the transparent substrate on which the holographic pattern is formed and the material layer is Δn, the depth of the holographic pattern is d, the wavelength of incident light is λ, and the order of diffracted light is m, the holographic pattern is formed to a depth satisfying
(Δn·λ−1)d=m·λ.

11. The compatible optical pickup according to claim 1, wherein the active compensation device acts on the polarization of light incident on the information storage medium and the polarization of light reflected by the information storage medium, respectively.

12. The compatible optical pickup according to claim 11, further comprising a quarter wave plate, interposed between the active compensation device and the information storage medium, to change the polarization of incident light.

13. The compatible optical pickup according to claim 11, wherein the material layer and the holographic pattern of the active compensation device respectively comprise:
a first material layer and a first holographic pattern acting on the light incident on the information storage medium; and
a second material layer and a second holographic pattern acting on the light reflected by the information storage medium.

14. The compatible optical pickup according to claim 1, wherein the active compensation device switches the incident angle of the light emitted by the light source irrespective of the polarization of the light.

15. An optical recording and/or reproducing apparatus comprising:
the optical pickup according to claim 1, movable along a radial direction of an information storage medium, to and record and/or reproduce information to and/or from the information storage medium; and
a control unit to control the optical pickup.

16. The optical recording and/or reproducing apparatus according to claim 15, wherein the first and third information storage media are respectively a blu-ray disc (BD) and a high-definition digital versatile disc (HD DVD) or vice versa, and the second information storage medium is at least one of a digital versatile disc (DVD) and a compact disc (CD), and wherein the first optical system emits the light suitable for use with at least one of the DVD and the CD to record or reproduce information on at least one of the DVD and the CD.

17. The optical recording and/or reproducing apparatus according to claim 16, wherein the wavelength of the light emitted by the light source is approximately 400 nm, a thickness of the first information storage medium is approximately 0.1 mm, and an effective numerical aperture of the objective lens for the first information storage medium is approximately 0.85;
a wavelength of the light suitable for use with the DVD is approximately 650 nm, a thickness of the DVD is approximately 0.6 mm, and an effective numerical aperture of the objective lens for the DVD is approximately 0.60;
a wavelength of the light suitable for use with the CD is approximately 780 nm, a thickness of the CD is approximately 1.2 mm, and an effective numerical aperture of the objective lens for the CD is approximately 0.45; and
a thickness of the third information storage medium is approximately 0.6 mm and the effective numerical aperture of the objective lens for the third information storage medium is approximately 0.65.

18. The optical recording and/or reproducing apparatus according to claim 16, further comprising:
an optical path changer, interposed between the light source and the objective lens, to change an optical path of the light;
a photodetector to receive light that is reflected by the first information storage medium and which passes through the objective lens and the optical path changer; and
an optical path coupler to couple an optical path of light emitted from the first optical system to an optical path of light emitted from the light source so that the light emitted from the first optical system is directed toward the objective lens.

19. The optical recording and/or reproducing apparatus according to claim 15, further comprising a second optical system to emit light to record and/or reproduce information onto/from the third information storage medium, wherein the first information storage medium is any one of a BD and a HD DVD, and the second and third information storage media are, respectively, a DVD and a CD or vice versa.

20. The optical recording and/or reproducing apparatus according to claim 19, wherein the second optical system comprises an infinite optical system.

21. The optical recording and/or reproducing apparatus according to claim 19, wherein a wavelength of the light emitted by the light source is approximately 400 nm, a thickness of the first information storage medium, and an effective numerical aperture of the objective lens for the first information storage medium are approximately 0.1 mm and 0.85, respectively, or 0.6 mm and 0.65, respectively;
a wavelength of the light suitable for use with the DVD is approximately 650 nm, a thickness of the DVD is approximately 0.6 mm, and an effective numerical aperture of the objective lens for the DVD is approximately 0.60; and
a wavelength of the light suitable for use with the CD is approximately 780 nm, a thickness of the CD is approximately 1.2 mm, and an effective numerical aperture of the objective lens for the CD is approximately 0.45.

22. The optical recording and/or reproducing apparatus according to claim 19, further comprising:
an optical path changer, interposed between the light source and the objective lens, to change an optical path of the light;
a photodetector to receive light that is reflected by the first information storage medium and which passes through the objective lens and the optical path changer; and
an optical path coupler to couple optical paths of light emitted from the first and second optical systems to an optical path of the light emitted from the light source so that the light emitted from the first and second optical systems is directed toward the objective lens.

23. The optical recording and/or reproducing apparatus of claim 15, wherein the light source emits light having a wavelength of approximately 400 nm.

24. The optical recording and/or reproducing apparatus according to claim 15, wherein, when a difference between the refractive indices of the transparent substrate on which the holographic pattern is formed and the material layer is Δn, the depth of the holographic pattern is d, the wavelength of incident light is λ, and the order of diffracted light is m, the holographic pattern is formed to a depth satisfying
(Δn·λ−1)d=m·λ.

25. The optical recording and/or reproducing apparatus according to claim 15, wherein the active compensation device acts on the polarization of light incident on the information storage medium and the polarization of light reflected by the information storage medium, respectively.

26. The optical recording and/or reproducing apparatus according to claim 25, further comprising a quarter wave plate, interposed between the active compensation device and the information storage medium, to change the polarization of incident light.

27. The optical recording and/or reproducing apparatus according to claim 25, wherein the material layer and the holographic pattern of the compensation device respectively comprises:
a first material layer and a first holographic pattern acting on the light incident on the information storage medium; and
a second material layer and a second holographic pattern acting on the light reflected from the information storage medium.

28. The optical recording and/or reproducing apparatus according to claim 15, wherein the active compensation device switches the incident angle of the light emitted by the light source irrespective of the polarization of the light.

29. A compatible optical pickup comprising:
a light source to emit light;
an objective lens that focuses the light to be incident on information storage media and which is optimized for use with a first information storage medium to which the light emitted from the light source is irradiated;
a first optical system to emit light suitable for use with a second information storage medium, the first optical system being configured as a finite optical system; and
an active compensation device to actively switch an angle of incidence of the light on the objective lens when either a third information storage medium that has a different format from that of the first and second information storage media, or the second information storage medium is adopted for use in a data recording/reproducing operation.

30. An active compensation device to provide for compatibility between various types of discs and an optical pickup including a light source to emit light, an objective lens which is optimized for use with a first disc, and a first finite optical system to emit light suitable for use with a second disc, the active compensation device switching an angle of incidence of the light on the objective lens when either a third disc, having a different format from that of the first and second discs, or the second disc is adopted for use so that the objective lens is effectively optimized for use with the second or third discs.

31. The active compensation device according to claim 30, wherein the first, second, and third discs are optical discs.

32. The active compensation device according to claim 30, comprising:
a plurality of transparent substrates; and
at least one material layer, interposed between the plurality of substrates, having a refractive index which is actively switched according to an applied voltage.

33. The active compensation device according to claim 32, further comprising a holographic pattern formed adjacent to the at least one material layer on a surface of at least one of the transparent substrates, the holographic pattern changing a divergence angle of the light by diffracting or transmitting, without diffraction, the incident light according to a change of the refractive index of the material layer.

34. The active compensation device according to claim 33, wherein the voltage applied to the material layer is adjusted according to the disc being used in the data recording/reproducing operation.

35. The active compensation device according to claim 30, comprising:
first and second transparent substrates;
two material layers which only act on a polarization state of light that is incident on the information storage medium and a polarization state of light that is reflected therefrom, interposed between the first and second transparent substrates, which has a refractive index that is actively switched according to an applied voltage;
a holographic pattern formed on at least one of the first and second transparent substrates; and
transparent electrodes, formed on the first and second transparent substrates, respectively, to apply the voltage to the material layer.

36. The active compensation device according to claim 35, wherein the material layer comprises an anisotropic material.

37. The active compensation device according to claim 35, wherein the material layer comprises a liquid crystal layer whose refractive index is switched according to an applied voltage.

38. The active compensation device according to claim 37, wherein individual liquid crystals in the liquid crystal layer are aligned to provide for polarization selectivity.

39. The active compensation device according to claim 37, wherein individual liquid crystals in the liquid crystal layer are aligned according to predetermined arrangements.

40. The active compensation device according to claim 35, wherein the holographic pattern changes a divergence angle of light by diffracting or transmitting incident light, without diffracting the incident light, according to a conversion of the refractive index of the material layer.

41. The active compensation device according to claim 40, wherein the holographic pattern produces a phase distribution that is proportional to the square of a radius from the center of the holographic pattern.

42. The active compensation device according to claim 30, comprising:
first, second, and third transparent substrates;
two material layers, which only act on a polarization state of light that is incident on the first disc and a polarization state of light that is reflected therefrom, the material layers being interposed between the first, second, and third transparent substrates, and having refractive indices that are actively switched according to an applied voltage;
first and second holographic patterns formed on the second and third transparent substrates, respectively; and
first through fourth transparent electrodes, formed on the first, second, and third transparent substrates, respectively, to apply voltages to the first and second material layers.
